(19) United States
(12) Patent Application Publication
(10) Pub. No.: US 2010/0224462 A1
(43) Pub. Date: Sep. 9, 2010

(54) CASH BOX COUPON FOR A GAMING MACHINE

(75) Inventors: Daniel Vienneau, New Brunswick (CA); Michel Vienneau, New Brunswick (CA); James P. Gabriele, Ontario (CA); Simcha C. Bielak, Ontario (CA); Dmytro Baydin, Ontario (CA)

Correspondence Address: SUGHRUE MION, PLLC, 2100 PENNSYLVANIA AVENUE, N.W., SUITE 800, WASHINGTON, DC, 20037, US

(73) Assignee: Nanoptix Inc., Dieppe, New Brunswick (CA)

(21) Appl. No.: 12/573,406

(22) Filed: Oct. 5, 2009

Related U.S. Application Data
(60) Provisional application No. 61/102,660, filed on Oct. 3, 2008.

(51) Int. Cl. G07D 7/00

(52) U.S. Cl. 194/302

(57) ABSTRACT

The present invention provides a method for an additional security feature on a gaming machine regarding the content of a cash box positioned within the gaming machine through the printing of a coupon. The method involves transferring information from a bill validator to a printer all within a gaming machine wherein the transfer of the information is achieved by a serial port connection between the bill validator and the printer.

The present invention also provides a system for an additional security feature to a gaming machine through the printing of a coupon containing information relating to the content of a cash box positioned within the gaming machine. The coupon is produced by information retrieved from the bill validator. The transfer of the information from the bill validator to the printer is achieved through a serial port interconnection between the bill validator and the printer.

### FIELD OF THE INVENTION

The invention relates generally to casino cash control systems and specifically to an additional security feature for the content of cash boxes in gaming machines.

### BACKGROUND OF THE INVENTION

In the early 1990's there was a fundamental change in the performance and capability of gaming machines initiated by the incorporation of bill acceptors into such machines. Bill acceptors are devices which receive paper currency (“currency”) and, using a validator having both hardware and software components, the received currency is scanned with a variety of sensors and the sensor information is analyzed to determine (1) authenticity and (2) denomination of the currency from the scanned data. If the scanned currency is determined to be authentic currency, e.g. a United States $1, $5, $10, $20, $50 or $100 bill or other legal tender currency, it is transported to a cash box within the bill acceptor for storage.

Based upon the denomination of the accepted currency, a signal is sent from the validator to the host machine's controller or processor to cause the machine to accumulate a corresponding amount of credits within the machine's credit meter representing the cash value or credits available for purchasing products or wagering, in the case of a gaming machine. As the user purchases products from or plays the machine, the purchase price or wager is debited from the credit meter. In the case of a gaming machine, wins are either accumulated as credits or paid out in coins. Acceptors of this type are known and are discussed for example in U.S. Pat. No. 5,863,039 issued Jan. 26, 1999 to Suzuki. Through the use of such bill validators, casinos have been required to carefully monitor the content of cash boxes within the gaming machine. However, the transfer of information from the bill validator is made generally through an existing central processing system which requires complex software to assure validity and security of the data from the bill validator.

Accordingly there is a need for a method and a system which allows for the production of a bar coded coupon from a gaming machine indicating the content of the cash box without the need of a casino's central processing system.

The above described and many other features and attendant advantages of the present invention will become apparent from a consideration of the following detailed description in conjunction with the accompanying drawings.

### SUMMARY OF THE INVENTION

It is an object of the present invention to provide a method that provides an additional security feature regarding the content of a cash box through the printing of a bar coded coupon. The method involves transferring information from a bill validator to a printer wherein the transfer of the information is achieved by a serial port connection between the bill validator and printer.

It is an object of the present invention to provide a system that allows for an additional security feature to a gaming machine through the printing of a coupon containing information relating to the content of a cash box positioned within the gaming machine. The coupon is produced by information retrieved from the bill validator. The transfer of the information from the bill validator to the printer is achieved through a serial port interconnection between the printer and bill validator.

### BRIEF DESCRIPTION OF THE DRAWINGS

It will now be convenient to describe the invention with particular reference to one embodiment of the present invention. It will be appreciated that the figures relate to one embodiment of the present invention only and are not to be taken as limiting the invention.

FIG. 1 is a flow chart setting out the steps for printing a bar code coupon regarding the content of a cash box within a gaming machine, according to one embodiment of the present invention.

FIG. 2 is a representative drawing of the interconnection between a printer and a bill validator according to one embodiment of the present invention.

FIG. 3 is a representative drawing of a bill validator and a cash box installed within a receiving structure according to one embodiment of the present invention.

### DETAILED DESCRIPTION OF THE DRAWINGS

The method of the present invention creates an additional audit trail for a casino employing gaming machines. A cash box from a gaming machine is generally replaced when it is either full or at night, however there may be other situations in which the cash box is also replaced. Upon removal of the cash box, the bill validator from the gaming machine produces a count of the cash within the cash box, for validation by the back office, where the cash is counted. The back office uses the count produced by the bill validator and compares it with the amount of cash in the cash box. This procedure of printing a ticket with information on cash counts provides extra security over the previously-existing accounting systems, in addition to providing casinos with the convenience of producing a cash count instantaneously.

The present invention will now be described more fully hereinafter with reference to the accompanying figures, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

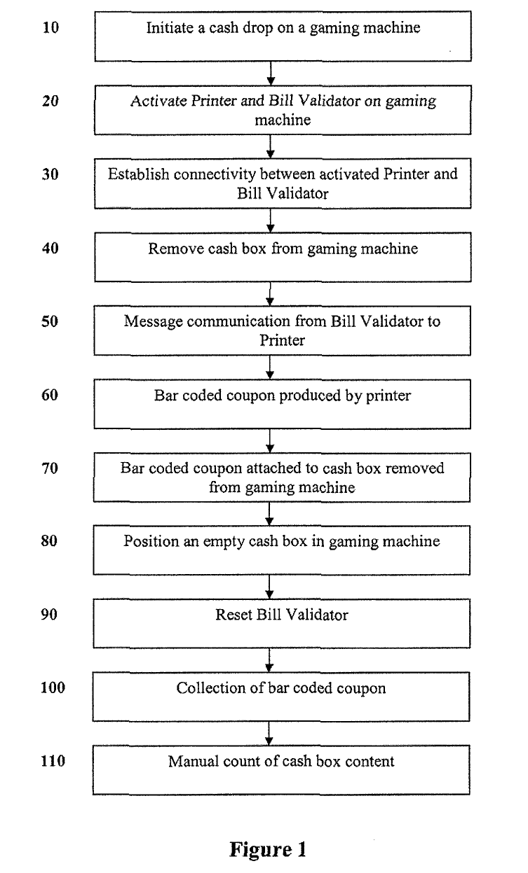

With reference to FIG. 1 and according to one embodiment of the present invention, at step 10, a cash drop on a gaming machine is initiated. A cash drop in relation to gaming machines occurs when a cash box is removed from a gaming machine and an empty cash box is positioned within the gaming machine. Cash drops are typically performed nightly, when the casino is nearly empty, by technicians. Sensors may also be present in each cash boxes that are triggered when the cash box is full. The signal is sent through the central system in the casino. If there is no central system, the technician may be advised that a cash drop has been initiated through a light illuminated on top of the gaming machine. A cash drop is not normally performed when a player is on a machine, but if the cash box is full, then play is suspended while the drop is performed by a technician. The gaming machines are emptied one at a time by a technician, but if there are several technicians on the floor at once, it is possible that several cash drops may be performed simultaneously.

With reference to FIG. 1 and according to one embodiment of the present invention, at step 20, the bill validator and the printer of a gaming machine are activated through a power source since a cash drop has been initiated. The bill validator initiates itself, meaning it resets its internal variables, all the while maintaining the cash count from its previous operation. The bill validator does not lose its cash count even when powered off and on again. The printer also initiates itself and ensures that it is working.

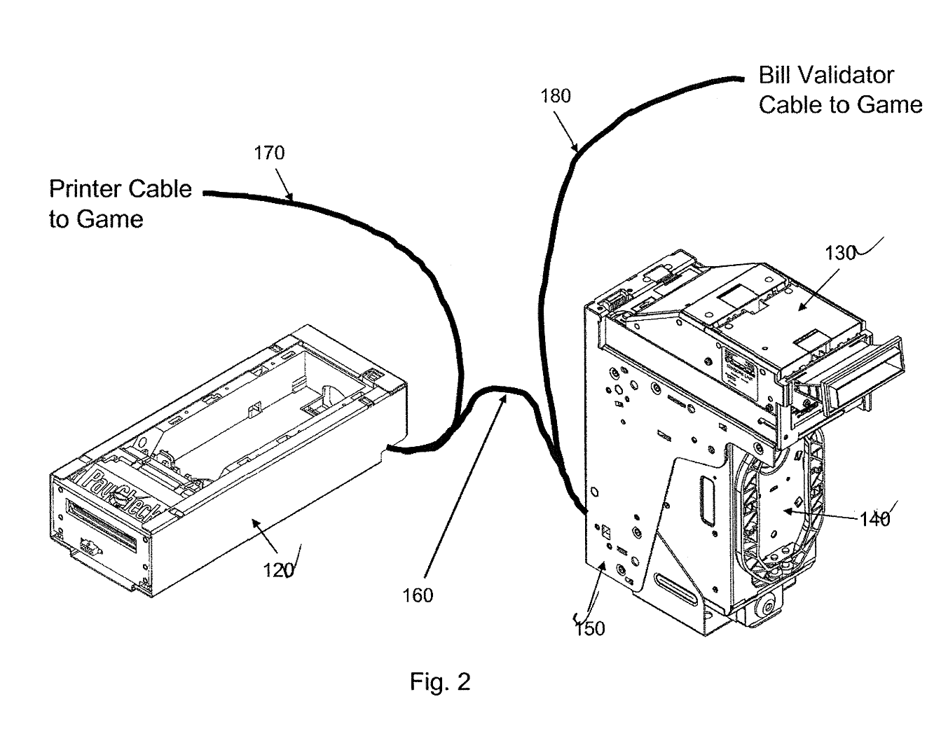

With further reference to FIG. 1 and according to one embodiment of the present invention, at step 30 the bill validator establishes connectivity to the printer by means of a serial port connection (as shown in FIG. 2). To achieve such connectivity, the bill validator sends initiation signals through the serial port connection, and the connection is established when the printer replies or by the printer simply receiving the information from the bill validator. By means of this direct link between the bill validator and the printer, the bill validator can produce a ticket containing the cash count within the cash box, without going through the central system. The absence of not having to go through the central system provides simplicity in that the firmware within the slot machine, which is connected and communicates with the central system, does not have to be changed in order to incorporate these features. It also avoids the need for the long and expensive process of jurisdictional approval. The connectivity of the bill validator and the printer of the gaming machine can be interrupted at any time by simply disconnecting a serial port connection at either the bill validator or at the printer when a dedicated connection is utilized to interconnect the bill validator and the printer.

With further reference to FIG. 1 and according to one embodiment of the present invention, at Step 40 a technician opens the security cage and removes the cash box from the receiving structure positioned under the bill validator contained within a gaming machine as would be known by a worker skilled in the relevant art.

With further reference to FIG. 1 and according to one embodiment of the present invention, at Step 50 and upon removal of the cash box, the bill validator sends a message to the printer through the serial connection, containing total cash value, the number of bills in the cash box by denomination, and the cash box Asset Number, which is a unique number assigned to the bill validator, related to the printed circuit board serial number. TITO (Ticket-in ticket-out) information is also sent within the message along with the number of bills, in order to facilitate accounting. A TITO ticket, containing a TITO bar code, is produced by a gaming machine for the player when they have some winnings on a gaming machine, but would prefer to take those winnings to another machine. The TITO bar code holds the balance of winnings information, which is then transferred to the new machine by means of the bill validator, which reads the balance and credits the player, so the player may continue playing. In other embodiments, the bill validator may also send information containing the bill validator's serial number, as well as the date, time, reference number for the drop, as well as other information not enumerated here. The data sent through the serial cable may also be encrypted.

With further reference to FIG. 1 and according to one embodiment of the present invention, at step 60, a bar coded coupon is produced once the information is sent to the printer which contains the information as described above. As would be known by a worker skilled in the relevant art, the coupon may not include a bar code but rather have a readable printout of the information retrieved from the bill validator. If the printer is not connected, or is out of order, then the message for producing a bar code is not sent and the gaming machine will continue to function as normal. The gaming machine is not affected by the operation or non-operation of the connection between the bill validator and printer. Since the connection does not impact the gaming machine, there is no need to modify the firmware within the gaming machine to handle the fault signal of a non-working connection. The gaming machine handles its signals in the normal manner in spite of the operation or non-operation of the communication link, for instance if the printer is out of paper, or the cash box is full, a signal may be sent to the central system and a light may illuminate. The presence of the communication link between the bill validator and the printer has no effect on the normal operation of the gaming machine, except to produce the information stated above in the form of a printed bar code or in the format as desired by the casino operators.

With further reference to FIG. 1 and according to one embodiment of the present invention, at Step 70 the technician collects the bar coded coupon and attaches it to the side of the cash box, by means of a pouch or the like.

With further reference to FIG. 1 and according to one embodiment of the present invention, at Step 80 the technician positions an empty cash box within the gaming machine and locks the security cage.

With further reference to FIG. 1 and according to one embodiment of the present invention, at Step 90, the bill validator, sensing that the cash box has been replaced, resets its figures of the cash contained in the cash box to zero. The counter is now ready to count the cash passed through the bill validator by the player as the gaming machine is used.

With further reference to FIG. 1 and according to one embodiment of the present invention, at Step 100, the back office collects the coupon with the cash box, and decodes the contents of the bar code using a standard bar code scanner. The decoded information is entered into a database for the use of the back office. A person skilled in the art would know that the bar code may be 1 dimensional, as in the standard UPC code, or 2 dimensional, as used in airline tickets, for example.

With further reference to FIG. 1 and according to one embodiment of the present invention, at Step 110, the cash box is counted manually or by other means, and the resulting amount is compared to the amount counted by the bill validator and collected by the back office in Step 100. The back office may then note and investigate any discrepancies between the amounts.

With reference to FIG. 2 and according to one embodiment of the present invention, a printer 120 is shown as would be found in a gaming machine. A bill validator 130 is also shown as would be found in a gaming machine. A worker skilled in the relevant art would be familiar with various power sources wherein the printer 120 and the bill validator 130 may have the same or different power sources. A worker skilled in the relevant art would also be familiar as to how to install both the printer and the bill validator in a gamin machine. A cash box 140 is positioned underneath the bill validator 130 wherein the bill validator 130 is operatively connected to the cash box. The cash box 140 is positioned under the bill validator 130 within a receiving structure 150 supporting the bill validator 130.

With further reference to FIG. 2 and according to one embodiment of the present invention, the bill validator 130 has a 9 pin D-sub connector and has screws to attach serial cable 160. A worker skilled in the relevant art would be familiar with the ability to incorporate the serial cable 160 within the respective harnesses 170 and 180 or in the alternative have a specific connection between the printer 120 and bill validator 130 to receive the serial cable 160. The printer 120 also incorporates a 9 pin D-sub connector and has screws to attach the serial cable 160. A worker skilled in the relevant would be familiar with a number of various connections which could be utilized in order to interconnect the printer 120 and bill validator as would be accepted by the gaming standards association or as technically required to achieve the transfer of information between the printer 120 and the bill validator 130. The protocol format between the printer 120 and the bill validator 130 shall be as per the Gaming Standard Association (GSA) Gaming Device Standard (GDS) Page Description Language (PDL) Specification. In one embodiment of the present invention, the current messaging between the printer 120 and the bill validator 130 is a one way communication from the bill validator 130 to the printer 120. In another embodiment of the present invention, a two way communication between the printer 120 and the bill validator 130 is installed which is compliant with GSA GDS PDL Specifications.

With further reference to FIG. 2 and according to one embodiment of the present invention, once the cash box 140 is removed from the receiving structure 150, the bill validator forwards information for printing by the printer 120. The various types of information which can be obtained from the bill validator 130 is described below which can be in the form of a report or coupon which are interchangeable.

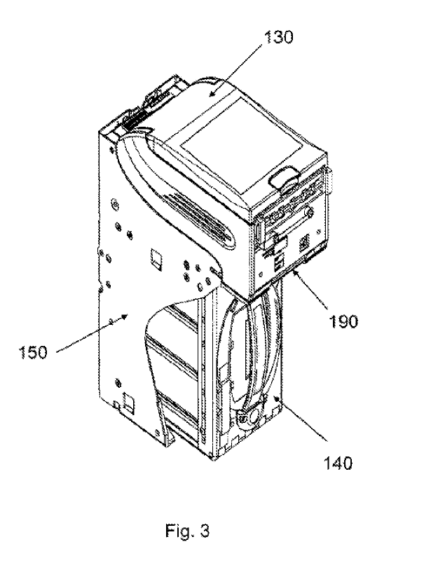

With reference to FIG. 3 and according to one embodiment of the present invention, the bill validator 130 and the cash box 140 are positioned within the receiving structure 150. The cash box 140 can be removed by applying pressure on the latch 190. Prior to removing the cash box 140 from the receiving structure 150, a technician can request various reports to be printed by the printer 120 based on information provided by the bill validator 130. For example, upon a technician pressing the latch 190 four times within six seconds a performance report is generated by the printer 120. The performance report in one embodiment of the present invention consists of two thermal tickets (not shown). One ticket shall have information about the printer 120. The other ticket has information about the bill validator 130. The use of two tickets allows a technician to attach either ticket to a printer or a bill validator that needs to be returned for service. The performance report provides the ability for a technician to verify as well the performance of either the printer 120 or the bill validator 130 without the need for special tools while at the machine. A further report can be obtained by pressing and holding the latch 190 for three seconds and a cash box audit and performance report is generated. The cash box audit and performance report can be in the form of a two-dimensional barcode. This report shall contain the contents of the cashbox and performance information of both the printer 120 and the bill validator 130. Once the cash box audit and performance report is sent from the bill validator 130 to the printer 120, the technician has 10 seconds to insert the cash box audit and performance report into the bill validator 130 for stacking to the cash box 140. The stacking operation is not reported to the machine and is not recorded as being an operation of the bill validator 130. The successful transfer of the cash box audit and performance report to the cash box 140 automatically clears the information in the bill validator memory. If the cash box audit report and performance report is not successfully transferred to the cash box 140, the bill validator memory is not cleared and another cash box audit and performance report has to be generated by the technician in order to complete the transfer of the cash box audit and performance report to the cash box 140 within the allocated time of 10 seconds.

In one embodiment of the present invention, the cash box audit and performance report is printed by using both a one-dimensional barcode to provide location information and a two-dimensional barcode to provide the cash box audit and performance report data. In an another embodiment, the cash box audit and performance report has two tickets wherein a first ticket has a two dimensional bar code with the cash box audit and performance data and a second ticket has a one-dimensional bar code and a text version of the cash box audit.

With further reference to FIG. 3, once the cash box audit and performance report has been successfully transmitted to the cash box 140, the cash box 140 is removed from the receiving structure 150 and a new cash box 140 is placed within the receiving structure 150. The cash box 140 removed from the gaming machine (not shown) is then transferred to a secure location in order to allow for the content to be removed and confirmed as defined on the cash box audit and performance report.

With further reference to FIG. 3 and according to another embodiment of the present invention, a last five report can be generated by the printer 120 by pressing on the latch 190 twice within six seconds. The purpose of this report is to assist operators in the event of a bill dispute on the casino floor.

In one embodiment of the present invention, the information contained in the various reports printed by the printer based on information provided by the bill validator would be known by a worker skilled in the relevant art. For example, the printer performance report could include date, time, gaming machine location, number of tickets printed, speed of the printer, temperature, HPQ burn time, voltage and baud rate. As a further example, the performance report from the bill validator could include information relating to the average acceptance rate, rejects based on sensors, settings, fast feed or others, number of bills jammed and the number of bills inserted. The cash box audit and performance report using a two dimensional bar code region will be printed based on information from both the bill validator and the printer. The printer will combine the cash box audit information and the bill validator statistics along with the printer's own statistics to create the bar code. A worker skilled in the relevant art would also be familiar with the inclusion of various logos or any other information that is contained within the printer and the bill validator.

In another embodiment of the present invention, a specific database may be required to interpret the data being shown on the various reports being generated once a cash box is removed from a gaming machine.

Many modifications and other embodiments of the invention will come to the mind of one skilled in the art having the benefit of the teachings presented in the foregoing description and associated drawings. Therefore, it is understood that the invention is not to be limited to the specific embodiment disclosed, and that modifications and embodiments are intended to be included within the scope of the appended claims.

The embodiments of the invention in which an exclusive property or privilege is claimed are defined as follows:

1. A system for an additional security feature for a gaming machine comprising:
i) a cash box in said gaming machine;
ii) a bill validator operatively connected to the cash box;
ii) a printer in said gaming machine; and
iii) a serial cable interconnecting the bill validator and the printer wherein a coupon is printed based on a transfer of information from the bill validator to the printer.

2. The system according to claim 1 wherein the cash box is installed within a receiving structure.

3. The system according to claim 2 wherein the receiving structure has a latch allowing for the removal of the cash box.

4. The system according to claim 3 wherein the latch allows for various reports to be printed based on the pressing on the latch prior to removing the cash box from the receiving structure.

5. The system according to claim 1 wherein the coupon printed by the system is in the form of a bar code.

6. The system according to claim 1 wherein the serial cable is integrated within a harness for the printer and a harness for the bill validator.

7. The system according to claim 1 wherein the serial cable is connected directly to the printer and the bill validator.

8. The system according to claim 1 wherein a software application is provided to interpret the information present on the coupon.

9. The system according to claim 1 wherein the coupon is a report.

10. A method for an additional security feature regarding the content of a cash box in a gaming machine comprising the steps of:
a. Initiating a cash drop on a gaming machine;
b. Activating a printer and a bill validator on a gaming machine;
c. Establishing connectivity between the activated bill validator and the printer on the gaming machine;
d. Removing the cash box from the gaming machine;
e. Transmitting information from the bill validator to the printer;
f. Emitting a coupon by the printer based on the information transmitted from the bill validator;
g. Attaching the coupon to the cash box removed from the gaming machine;
h. Positioning an empty cash box within the gaming machine;
i. Resetting bill validator;
j. Collecting coupon from cash box; and
k. Verification of content of cash box based on coupon.
